(19) United States
(12) Patent Application Publication
(10) Pub. No.: US 2009/0129068 A1
(43) Pub. Date: May 21, 2009

(54) Maxi-storm light

(76) Inventor: Allan James Finch, Burnaby (CA)

Correspondence Address: Allan James Finch, 5149 Lorraine Ave., Burnaby, BC, V5G 2S3, CA

(21) Appl. No.: 12/228,138

(22) Filed: Jan. 9, 2007

(51) Int. Cl. F21L 4/02

(52) U.S. Cl. 362/183; 362/157; 362/191

(57) ABSTRACT

An independently powered hand-held signaling device which makes use of a large capacity of LED's that are basically sandwiched creating a large cavity of transferring light. Between the two semi-transparent panels the bright light provides illumination in two directions providing illumination through info on both panels, in two opposite directions. The unit does not have to be depending on reflective light to be visible. A switch on the side of handle provides steady on or a light source for flashing mode. The unit has its own electrical power source which can be recharged from an auto or 120 volt source. The molded body handle and frame is connected and makes use of a polygon frame. Fasteners for holding the information panels allow for quick change. At the base of the unit is a feature, where the user can attach a pole for extended use or a strap to hold on to the unit. The unit is basically used while arm is extended.

### BACKGROUND OF THE INVENTION

1. Field of Invention

The improved light is enhanced assistance in safety or a distinct marker in sports Events that can communicate messages by night or day . . . .

2. Prior Art

Originally safety and markers have relied on bright paint in traffic Safety and in many sports events many of these forms of signage were reliant on day light or by night Requiring an ambiance of reflective light to assist in their being visual. The recent history has been upgraded using reflective paint or phosphorescent paint relying on reflective light.

Some Inventions from the past shone light in one direction relied on wired apparatus or low quality batteries which lower the desirability required in portability of larger signs. Failure in acceptance of many products suffered from poor power source or recharging elements controlling longevity of use, while relying on a back-up of batteries.

The improved quality of light components and rechargeable batteries are the factors that Make this flashing “Max-Storm Light” invention more feasible at this time. The high Quality of these factors makes this plastic embodiment manufactured product design very efficient in the required fields: camping, hiking mountain climbing traffic safety, police and major sports events.

### DRAWING FIGURES

FIG. 1 Is a view showing user of independently powered portable frame hand held graphics supporter showing my new design, illuminating in two directions.

FIG. 2 is a dissected side view.

FIG. 3 is an interior view without parallel imagery panels.

FIG. 4 is a view with imagery panels installed.

FIG. 5 is an exploded view.

FIG. 6 Is a bottom view.

FIG. 7 Is a top view.

FIG. 8 Is a dissected view showing location of illuminated light cavity.

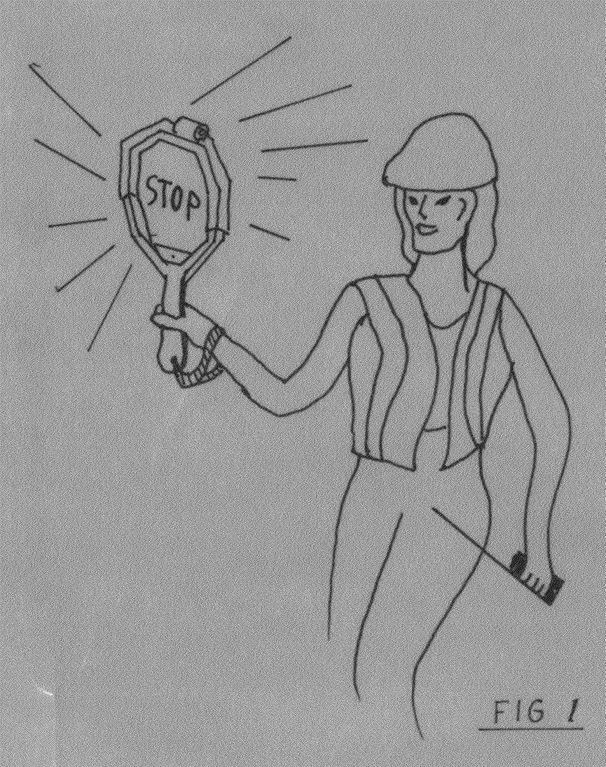

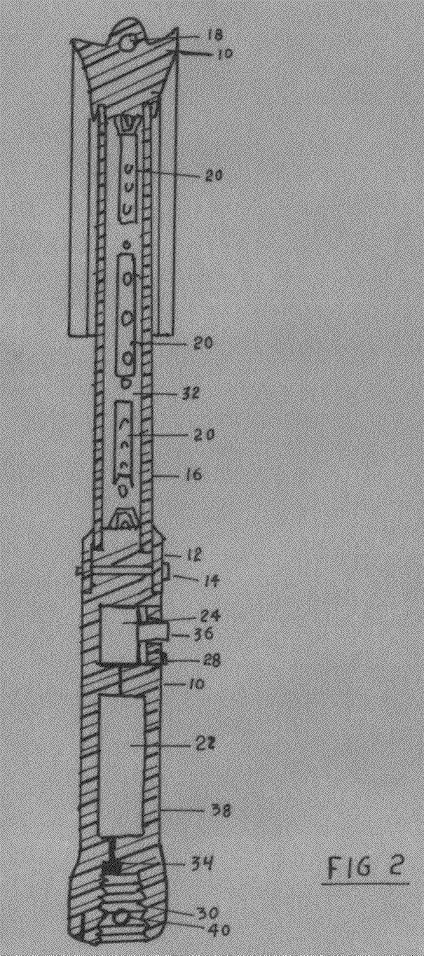

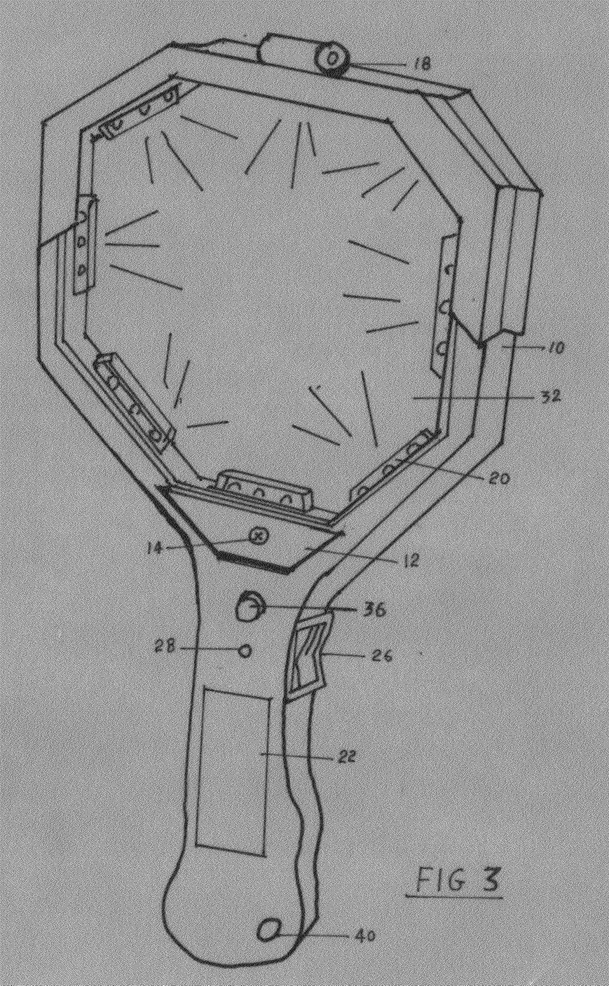

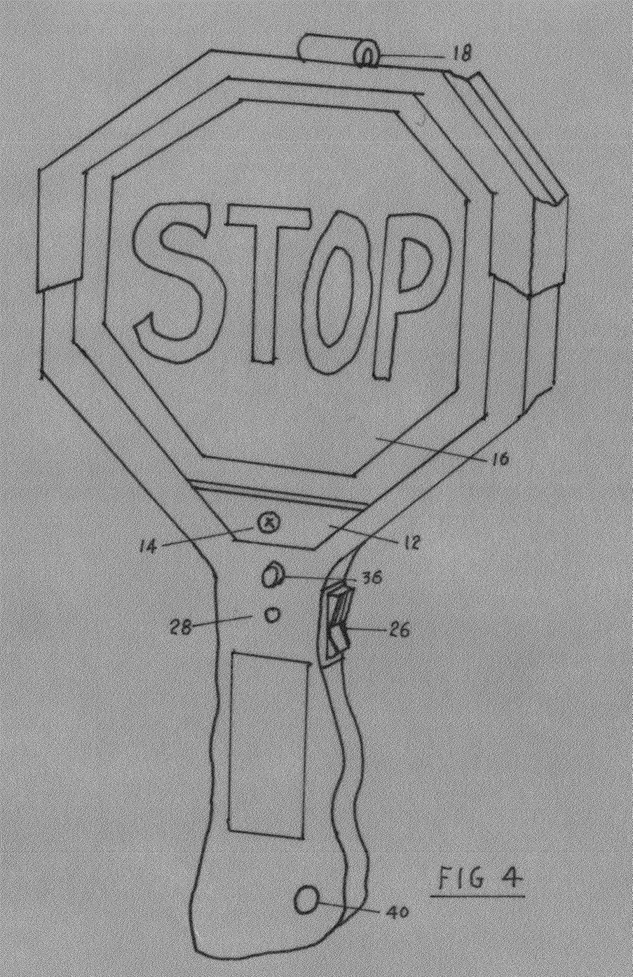

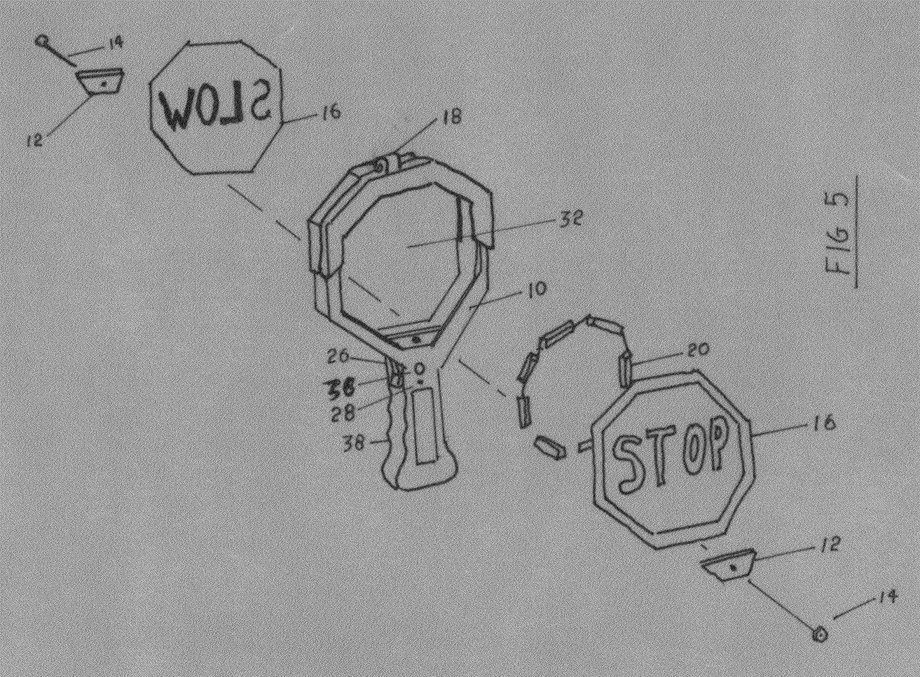

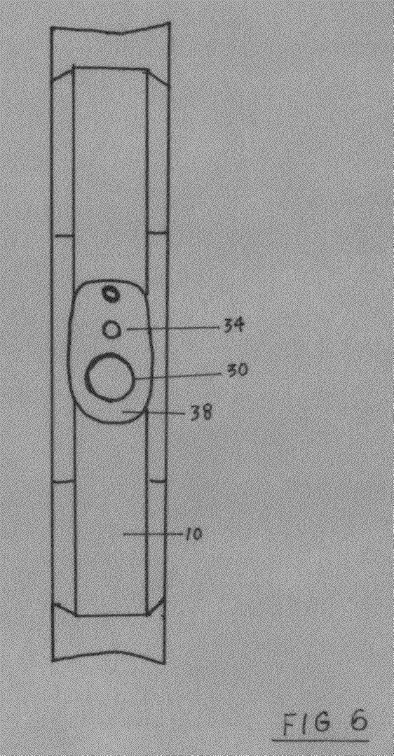

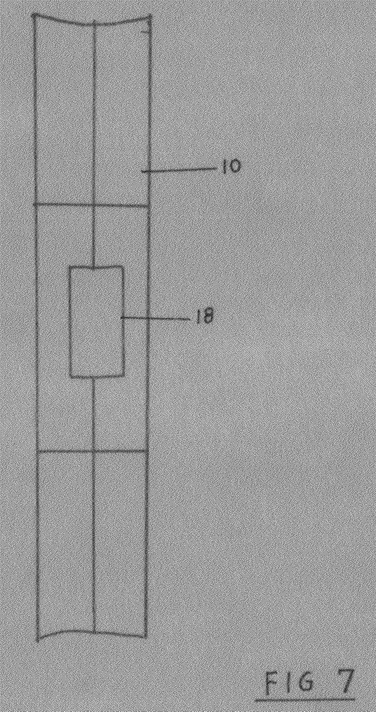

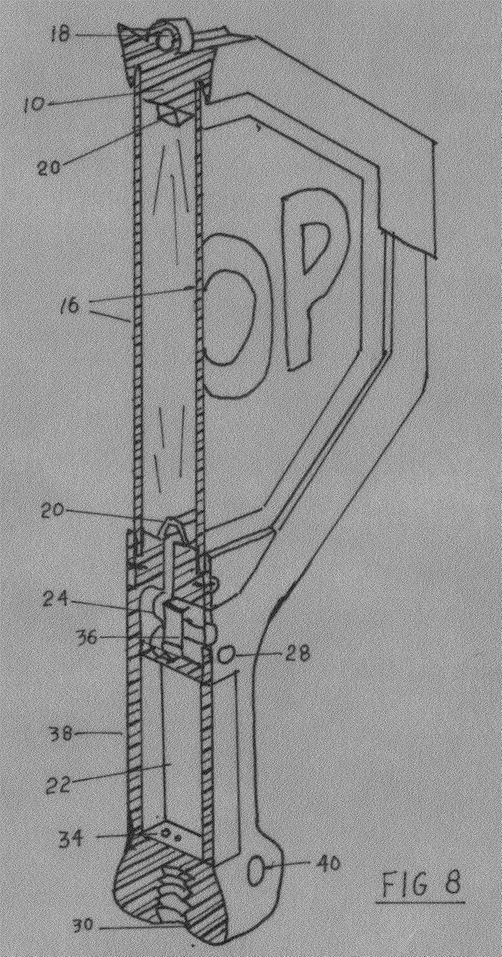

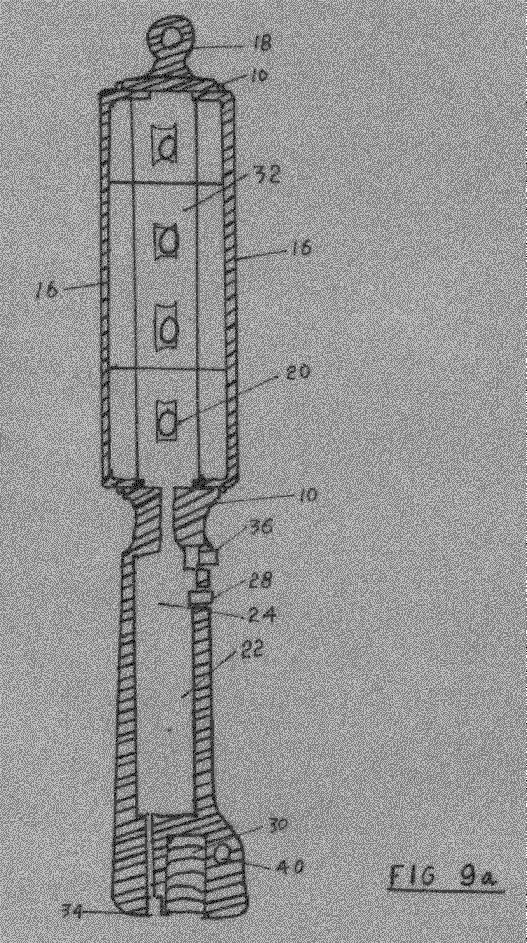

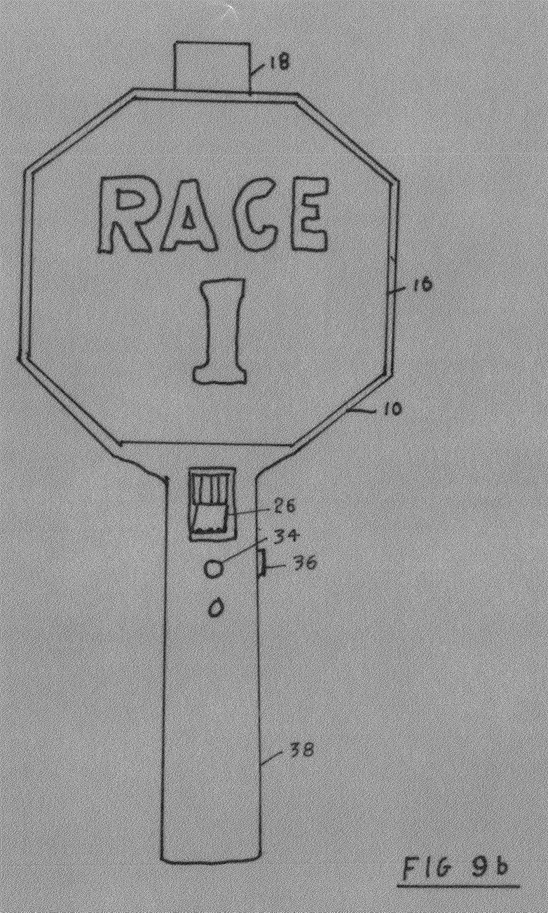

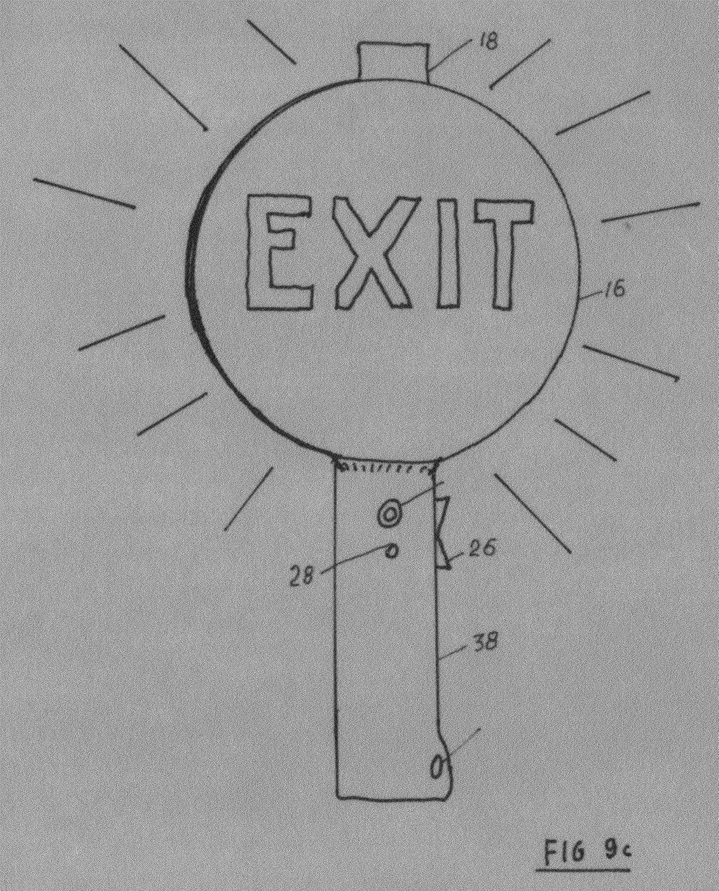

### ALTERNATIVE EMBODIMENTS

FIG. 9a is a dissected side view of cap panels inserted into frame using friction retention.

FIG. 9b is a view showing lighter clean lines using cap shaped panels

FIG. 9c is a front view showing the upper embodiment and panel in circular shape

### DRAWINGS REFERENCE NUMERALS

10. frame
12. retainer
14. nut and bolt
16. panel
18. hanger
20. light component
22. Rechargeable battery pack
24. Wiring
26. Rocker Switch flasher mode.
28. Recharge warning light
30. long extension pole access
32. light chamber
34. Recharge access
36. main power switch
38. Handle
40. wrist strap hole

### FEATURE DESCRIPTION

My new light is capable of portability, possessing a battery pack and is characterized by two parallel panels. With abundance of light, between to back light any graphics supported on the outside of the panels.

1. This hand-held light offers an independent light source, in two opposite directions.

2. The quick panel removal for projecting two different messages at night.

3. This unit's frame is constructed from brightly colored, light, strong, molded plastic.

4. The flat message panels on each side can be interchanged quickly.

5. This product can be produced in different sizes to give consumer choice in usage.

6. This unit makes use of an economical LED's components for added longevity.

7. Hanger access, in emergency the unit can be suspended front or back off a truck.

8. Removing one or two panels would offer a powerful trouble light source.

9. This unit is equipped with ac/dc battery charging features for auto or home.

10. In the handle there is a place to insert a long extension pole, for highway usage.

11. There are switches to activate flashing mode from steady on.

12. Led lights on unit that indicate recharging required.

13. The panels can be exchanged, to make visible messages for day or night.
